(19) United States
(12) Patent Application Publication
(10) Pub. No.: US 2015/0077614 A1
(43) Pub. Date: Mar. 19, 2015

(54) ROTATE-PAN-TILT CAMERA FOR VIDEOIMAGING, VIDEOCONFERENCING, PRODUCTION AND RECORDING

(71) Applicant: Simon P King, Annapolis, MD (US)

(72) Inventor: Simon P King, Annapolis, MD (US)

(21) Appl. No.: 14/461,799

(22) Filed: Aug. 18, 2014

Related U.S. Application Data
(60) Provisional application No. 61/866,728, filed on Aug. 16, 2013.

(51) Int. Cl. G03B 17/56; H04N 5/372; H04N 5/225

(52) U.S. Cl. CPC G03B 17/561; H04N 5/2251; H04N 5/2256; H04N 5/372
USPC 348/311

(57) ABSTRACT

The present invention is a videoimaging system with boom-mounted pan-tilt-zoom video camera in which the camera core is mounted on a remotely-controlled rotate-pan-tilt mount for three-axis rotation about three mutually orthogonal axes, a vertical yaw axis, a horizontal roll axis, and a horizontal pitch axis, all three axes intersecting at a common point. Rotation of the camera core about the yaw axis varies the azimuth (compass bearing) of the pointing direction of the camera, rotation about the roll axis varies the angular orientation of the field of view, and rotation about the pitch axis varies the altitude (angle of elevation) of the pointing direction. The camera and lighting unit disclosed herein provides a remote control zoom and improved pan-tilt mechanism for videoimaging, videoconferencing, production, lighting and recording.

### CROSS-REFERENCE TO RELATED APPLICATION(S)

The present application derives priority from U.S. provisional application Ser. No. 61/866,728 filed 16 Aug. 2013.

### BACKGROUND OF THE INVENTION

1. Field of the Invention

The present invention relates to a videoimaging system/camera and, more specifically, to a videoimaging system with a remote controlled rotate-pan-tilt-zoom video camera providing three-axis movement of the camera lens and optional high intensity light source.

2. Description of the Background

Video production services are commonly required in medical settings, including academic surgical procedural programs, to teach students, to present promotional programs for seminar and workshop capture, for patient education programs, etc. In addition, there are many remote telemetering applications that require video production, for example, in geographic areas where rural physicians and health practitioners need continuing education or real-time guidance from experts in carrying out various surgical procedures. Many surgeries are now broadcast by live event video production and internet broadcasting or satellite uplink. Whether recorded program production, live event production, or telemetering, all such applications require extensive production above the surgical field, or patient area of interest.

There have been few attempts. One effort is described in United States Patent Application No. 20030142204 by Russ, Steven H. filed Jul. 31, 2003. This application discloses a surgical lighting control and video system that gives a user access to multiple devices at one station and makes control of the system simpler and more intuitive. A graphical LCD display is used to control a plurality of devices, such as overhead lighting, ambient lighting, cameras, and other operating room accessories. A voice interface allows the surgeon to adjust lighting and other aspects by simply speaking A foot pedal interface and an infra-red remote control interface grant the surgeon control of the cameras, enabling direct control of rotate and zoom functions of the camera.

It has since been found that tremendous enhancements can be attained by use of a remote controlled rotate-pan-tilt-zoom camera and optional lighting unit having a remotely-controlled video camera and light source (particularly an adjustable high-intensity light source such as fiber optic or the like) sharing the same optical path. The present inventor in his U.S. Pat. No. 7,982,763 provides a portable pan-tilt camera and lighting unit for standalone use in videography to create a high-resolution well-illuminated video feed from a vast array of camera angles and positions, the illumination source always inherently tracking with the camera. The unit may also be used as a satellite in combination with a primary video conferencing and production station (VVPR) for multi-camera production and teleconferencing capabilities. The portable camera and lighting unit includes a portable base, a mast extending upward from the base, and an articulating boom that is fully-pivotable and extendable. A remote control Pan-Tilt-Zoom camera is mounted at the end of the boom for overhead images of healthcare procedures, and an adjustable beam light source is mounted directly on the camera for lighting. The mast is equipped with a color monitor coupled to the camera for operator previewing at the portable unit, and the remote control camera provides a single video feed that can be teleconferenced, recorded, and even mixed with other cameras when used as a satellite adjunct to the primary VVPR, thereby allowing full production capabilities for live interactive broadcasts, all in real time by a single operator from a single point of control.

It has since been found that more diverse camera angles can be attained by adding a third axis of movement (rotate) to the existing two axis (pan-tilt) movements of the remotely controlled camera and optional light source (particularly an adjustable high-intensity light source such as fiber optic or the like) sharing the same optical path. The rotate, or third axis of the camera lens provides the capability of adjusting the angle of the camera lens as needed, without adjusting the camera boom, or otherwise moving the position of any portable solution upon which the camera is mounted. As an example, the camera is fixed to a boom in an operating room, placed above the surgical field. The camera lens is positioned to emulate the eyes of the surgeon and has the capability to pan-tilt and zoom around the surgical field to effectively capture the desired content. As the surgeon physically moves around the operating room table, his view of the surgical field changes. By adding the third axis (rotate), the camera lens viewing angle is adjusted to enable the camera to capture the same image of the surgical field or patient area of interest as the eyes of the surgeon. Without the third-axis rotate functionality, if the surgeon moves to the opposite side of the surgical table (180°), the view of the surgical field would be upside down. Prior art remote camera solutions lack any remote pan-tilt functionality, significantly limiting the ability to move the camera lens around the surgical field. Applicant's U.S. Pat. No. 7,982,763 addresses the value of a pan-tilt-zoom (PTZ) camera for capturing surgical content. Further combining a rotate functionality with PTZ can enhance that value, and the invention disclosed herein provides an optimal solution.

### SUMMARY OF THE INVENTION

It is therefore an object of the present invention to provide a rotate-pan-tilt video camera and lighting unit for video imaging and production in many different applications, such as medical/surgical imaging, engineering and remote diagnostics, video conferencing, etc.

It is another object to provide a rotate-pan-tilt camera and lighting unit incorporating a remotely-controlled rotate-pan-tilt video camera as well as an adjustable-beam light source sharing the same optical path, for video imaging, videoconferencing, production and recording.

It is still another object to provide a camera and lighting unit controllable by a single trained person to provide complete control over high-resolution video capture and lighting therefor, for real time video communications between diverse locations such as hospital operating room/procedure room environments and other remote locations for education, consulting, remote surgical assistance, diagnostics, demonstrations, and the like.

It is still another object to provide a satellite camera and lighting unit as described above that is suited for providing a standalone video feed, or alternatively, that integrates seamlessly with the primary surgical video imaging station (“VVPR”) as shown and described in applicant's above-cited U.S. Pat. No. 7,982,763, the portable unit communicating directly and being controlled by the VVPR for multi-camera surgical video imaging all controllable by a single trained person to provide a complete array of audio and high-resolution video capture tools, mixing and editing tools, recording capabilities to a variety of common analog and digital formats, and real time video and data communications capabilities for networked communications for teleconferencing between hospital operating room/procedure room environments and other remote locations for education, consulting, remote surgical assistance, diagnostics, demonstrations, and the like.

It is another object to provide a camera and optional lighting unit suitable for mounting on the fixed or articulating boom of any remote video imaging solution, to provide rotate-pan-tilt capability about three-axes of rotation of the camera core and optional light source for high-resolution close-up surgical imaging from multiple camera angles.

In accordance with the foregoing objects, the present invention is a video imaging system with remote-control video camera, the camera core (CCD imaging and zoom lens assembly) being mounted on a remotely-controlled rotate-pan-tilt mount for three-axis rotation about three mutually orthogonal axes: a vertical yaw axis, a horizontal roll axis, and a horizontal pitch axis, all three axes intersecting at a common point for improved video imaging of the surgical field, or other patient area of interest. The video camera of the present invention is optimized for mounting on a mobile/portable video-imaging unit and the rotate-pan-tilt-zoom functionality provides the capability of adjusting the angle of the camera lens as needed, without adjusting any camera boom, or otherwise moving the position of the mobile/portable video-imaging unit. Rotation of the camera core about the pan axis varies the azimuth (compass bearing) of the pointing direction of the camera, rotation about the roll axis varies the angular orientation of the field of view, and rotation about the pitch axis varies the altitude (angle of elevation) of the pointing direction. The camera and lighting unit disclosed herein provides a remote control zoom and improved pan-tilt mechanism for fast, accurate, and flexible remote positioning of the video camera core and optional lighting fixture toward any location including hospital operating room/procedure rooms, field locations, or other remote locations for purposes of sourcing video data communications there from for education, consulting, surgical assistance, diagnostics, demonstrations, and the like.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a perspective view of the rotate-pan-tilt camera and lighting unit 2 according to the present invention mounted at the end of a boom 4 for overhead images.

FIG. 2 is a perspective view of the rotate-pan-tilt camera and lighting unit 2.

FIG. 3 is a bottom view of the rotate-pan-tilt camera and lighting unit 2.

### DETAILED DESCRIPTION OF THE PREFERRED EMBODIMENTS

The present invention is a portable rotate-pan-tilt camera and lighting unit for standalone use in obtaining a well-lit high-resolution video feed during video imaging. The camera and lighting unit of the present invention is optimized for mounting on a mobile/portable video-imaging unit, the 3-axis rotate-pan-tilt-zoom functionality of the lens carriage providing the capability to adjust the angle of the camera lens as needed, without adjusting any camera boom, or otherwise moving the position of the mobile/portable video-imaging unit. Given its remotely-controlled operation, the device may be used as a satellite unit in combination with virtually any other existing video imaging solution, including a mobile video imaging, videoconferencing, production and recording (VVPR) station. Whether used alone or as a satellite, the portable camera and lighting unit is designed for direct control by a single trained person during video imaging to provide a self-contained lighting solution and to form a real time video feed for networked communications and teleconferencing between hospital operating room/procedure room environments and other remote locations for education, consulting, remote surgical assistance, diagnostics, demonstrations, and the like.

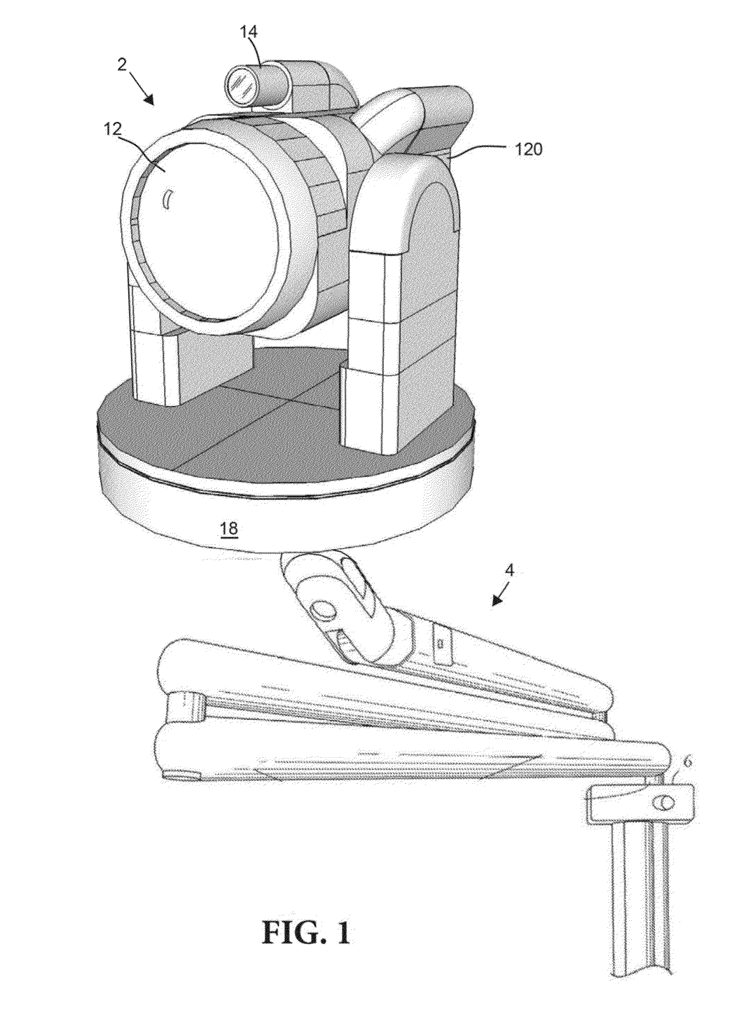

FIG. 1 is a front perspective view of the rotate-pan-tilt camera and lighting unit 2. Camera and lighting unit 2 generally comprises a fully-articulated video camera and lighting system (to be described) here mounted on an articulating boom 4, which is in turn mounted on a support mast 6 that extends upwardly from a mobile or stationary platform. The rotate-pan-tilt camera and lighting unit 2 comprises a remote control zoom video camera core 12 for overhead images of healthcare procedures. Optionally, a focused-beam light source 14 is also provided on camera core 12 for illuminating rotate-pan-tilt camera 12 shots. One skilled in the art will understand that a variety of light sources may be suitable such as fiber-optic projection light sources, LEDs, fluorescent or incandescent, as desired. The illustrated light source 14 comprises an LED light source mounted directly proximate the lens of the camera core 12 (as will be described) to direct a focused light beam along the same path as the camera image. This way the camera core 12 is capable of providing continuously illuminated overhead images of healthcare procedures, and the spot beam tracks the camera filed-of-view. The light source 14 is mounted on the camera core 12 within a camera core housing 120.

The camera core housing 120 is mounted on an articulating rotate-pan-tilt base 18 which is mounted by screw threads directly to the distal end of boom 4 thereby providing additional angle capability to supplement the camera's inherent remote control pan/tilt/zoom capabilities.

The resulting camera and lighting unit 2 is designed to be manned and controlled remotely by a single operator as opposed to a full production crew, even when used in conjunction with a separate VVPR (which has additional remote control cameras). Thus, remote control camera and lighting unit 2 may be controlled remotely from an infrared controller, or from a joystick mounted on a VVPR (not shown). Likewise, the camera and lighting unit 2 may be connected to any NTSC receiver, or to the mixing and video production equipment in the VVPR as well as the teleconferencing and networking equipment.

Camera and lighting unit 2 is adapted for three-axis rotation about three mutually orthogonal axes, a vertical pan axis (Y), a horizontal roll axis (R), and a horizontal pitch axis (P), all three axes intersecting at a common point for improved videoimaging, videoconferencing, production, lighting and recording. This is accomplished with a unique rotate drive gear attached coaxially at the rear of the camera core 12, in combination with a planetary pan drive and a tilt drive.

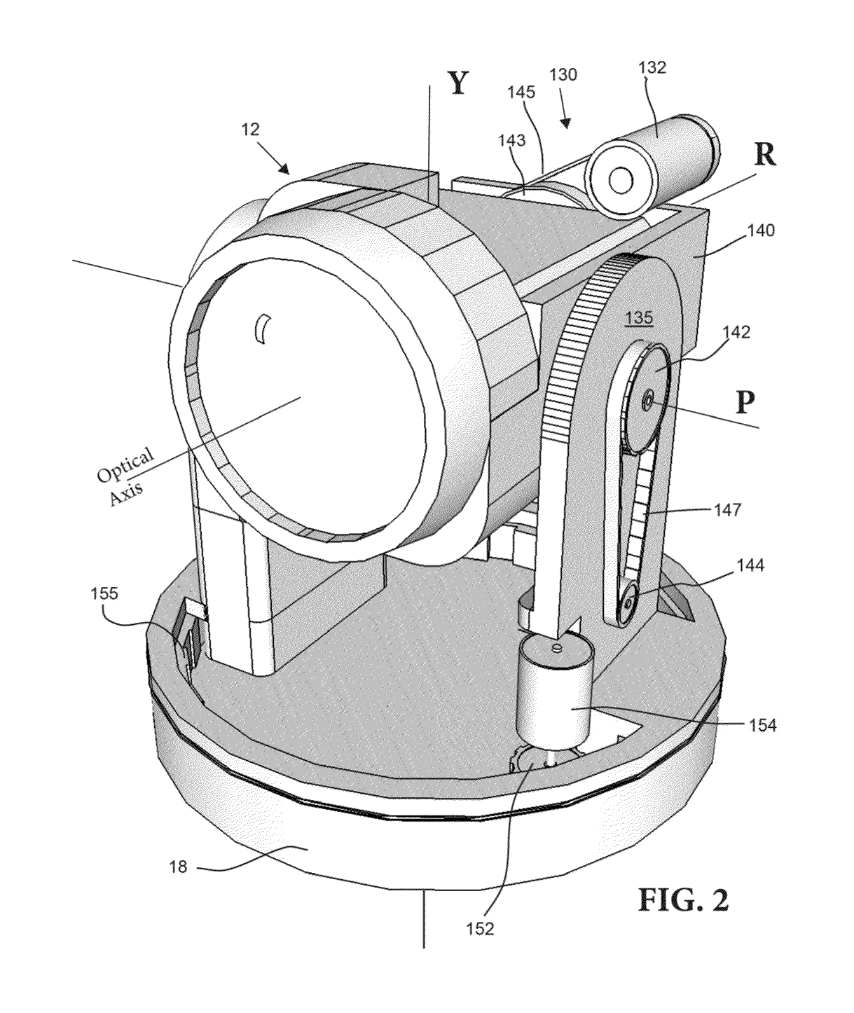

FIG. 2 is a disassembled perspective view of the rotate-pan-tilt drive gear of camera system 2 attached coaxially at the rear of the camera core 12, in combination with a planetary pan drive and a tilt drive camera 12 mounted at the end of the boom 4 for overhead images. As mentioned above, camera system 2 includes a housing 120 enclosing a video camera core 12 which is an assembly of camera components that preferably includes optical, imaging, and electronic components. An example of a suitable camera core 12 for use in the present invention is the model PTC-400C camera core available from Elmo®. That camera core includes uncooled electronic printed circuit board assembly (PCBA) with circuit boards for video signal processing and for pan, tilt and zoom operations, a 12× optical zoom lens, a power supply, a zoom lens assembly and a mounting.

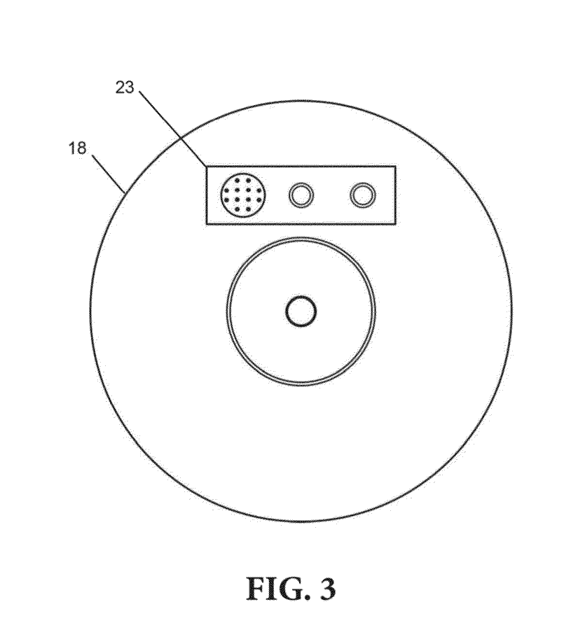

FIG. 3 is a bottom view of the camera system 2. Since the base 18 is stationary, the camera core 12 may be connected by conventional cables running to a patch panel 23 mounted on the bottom of the base 18. The rotate-pan-tilt of the camera core 12 is controlled individually by a controller mounted on the satellite unit 2, or by wireless remote controller.

Referring back to FIG. 2, the camera core 12 is mounted on a unique rotate-pan-tilt mount controlled individually by a controller mounted on the satellite unit 2 or by wireless remote controller, for three-axis rotation about three mutually orthogonal axes, a vertical pan axis (Y), a horizontal roll axis (R), and a horizontal pitch axis (P), all three axes intersecting at a common point for improved videoimaging, videoconferencing, production, lighting and recording. This is accomplished with a circular roll drive 130 integrated into the rear of the camera core 12. The camera core 12 itself is mounted to an L-shaped pitch/roll bracket 140 by a bearing 143 that extends rearwardly from camera core 12 along the roll axis (R), leaving the camera core 12 free to rotate along the roll axis (R). The L-shaped pitch/roll bracket 140 extends out to the side and is angled inwardly alongside the camera core 12 to its pitch axis (P). A roll-drive servo motor 132 mounted alongside camera core 12 engages the camera core 12 such as, for example, by a pulley 145 about the bearing 143 (or bearing axle). One skilled in the art should understand that the roll-drive servo motor 132 may alternately employ a direct drive gear or other coupling for rotating the camera core 12. Motor 132 controllably varies the angular orientation of the field of view of camera core 12 around the roll axis (R). The other arm of pitch/roll bracket 140 wraps around the broadside of camera core 12 and is pivotally mounted on an axle to the upper portion of a vertical support bracket 135. The axle is rotatably journaled (e.g., through a bushing) through the bracket 135 and has a circular pitch drive gear 142 attached to it on the farside of bracket 135 coaxial with the pitch axis (P). A pitch-drive servo motor 144 mounted inside base 18 engages the pitch drive gear 142 via pulley 147 to vary the altitude (angle of elevation) of the pointing direction of camera core 12 around the pitch axis (P). Finally, the bracket 135 is mounted on a rotating platform (not shown) that sits atop circular base 18. An inner pan ring gear 155 encircles the inside of base 18. A pan-drive servo motor 154 mounted alongside support bracket 135 extends a pan drive gear 152 down into base 18 to engage ring gear 155, and as servo motor 154 rotates pan drive gear 152 it engages ring gear 155 and rotates the platform about base 18, effectively rotating the entire camera core 12 about the pan axis (Y). This varies the azimuth (compass bearing) of the pointing direction of the camera core 12 around the pan axis (Y). Note that all three orthogonal axes (Y, R, P) intersect at a common point. The net result is a remote control zoom and improved pan-tilt mechanism for fast, accurate, and flexible remote positioning of the video camera core (and optional lighting system 10) toward any location including hospital operating room/procedure rooms, field locations, or other remote locations for purposes of sourcing video data communications there from for education, consulting, surgical assistance, diagnostics, demonstrations, and the like. The adjustable-beam LED projection lens 14 (see FIG. 1) is likewise mounted directly atop the camera core 12 and is at least partially encased within housing 120. The adjustable lens LED light 14 is fixed to point along the exact same optical viewing path of camera core 12, and since it is fixedly attached to the camera core 12 LED light 14 will always be directed along the same optical viewing path as camera core 12 regardless of the remote controlled orientation. T

Referring back to FIG. 1, when in use, the boom 4 may be extended and angularly positioned as desired to position the rotate-pan-tilt camera and lighting unit 2 directly overhead the operating site. LED projection lens 14 may be adjusted to illuminate the entire camera field of view. These adjustments are then fine-tuned by remote control positioning of the camera core 12 lens along Y, R, P axes. As a surgery proceeds, the operator can control the single live video feed and illumination therefore to provide a live high resolution video feed for networking, teleconferencing, and/or recording. Note that if the boom 4 is set so that the camera and lighting unit 2 is inverted, an inverted image is avoided simply by remotely inverting the camera core 1w2 around its roll axis (R). If connected to a VVPR full production capabilities are added, and the operator can multiplex the camera signals from the rotate-pan-tilt camera and lighting unit 2 with those of the VVPR and produce in any known format such as Mini-DV, S-VHS, VHS and DVD recordings for the surgeon to leave with a copy to present at his/her next presentation if desired.

The rotate-pan-tilt camera and lighting unit 2 set forth above excels at providing a standalone high-resolution well-illuminated video feed from a vast array of camera angles and positions, the illumination source always inherently tracking the camera. Moreover, the portable unit integrates seamlessly with virtually any primary surgical videoimaging solution, including the VVPR such as shown and described in applicant's above-cited application, thereby providing full conferencing and production capabilities. In both cases the present portable camera and lighting unit improves the flexibility, resolution and diverse camera angles of the interactive video and data production and communications between hospital operating room/procedure room environments and other remote locations for education, consulting, surgical assistance, diagnostics, demonstrations, and the like. Imaging can be accomplished by a single trained operator, replacing the traditional team of videographers.

Moreover, the portable camera and lighting unit 2 has a footprint well-suited for enclosed environments (such as hospital operating rooms), all power components are safely contained in an aesthetically-pleasing base cabinet, and the fully-articulating boom-mounted video camera gives high-resolution close-up imaging for a myriad of applications.

Having now fully set forth the preferred embodiments and certain modifications of the concept underlying the present invention, various other embodiments as well as certain variations and modifications thereto may obviously occur to those skilled in the art upon becoming familiar with the underlying concept. It is to be understood, therefore, that the invention may be practiced otherwise than as specifically set forth herein.

I claim:

1. A rotate-pan-tilt-zoom video camera, comprising:
a housing;
a camera core including a CCD imager, zoom lens assembly, and a circuit board for video signal processing and pan, tilt and zoom control;
a remotely-controlled rotate-pan-tilt mounting inside said housing supporting said camera core for three-axis articulation about three mutually orthogonal axes including a vertical yaw axis, a horizontal roll axis, and a horizontal pitch axis, said rotate-pan-tilt mount further comprising,
a roll drive mechanism comprising one of a pulley or gear attached coaxially at the backside of the camera core to vary angular orientation around the roll axis,
a roll-drive servo motor engaged to said roll drive mechanism,
a pitch/roll bracket having one arm attached at the roll axis at the rear of the camera core and another arm angled around broadside of the camera core,
a pitch drive mechanism comprising one of a pulley or gear attached to the pitch/roll bracket coaxial with the pitch axis to vary the altitude of the pointing direction of the camera core,
a pitch-drive servo motor engaged to said pitch drive mechanism,
a yaw bracket having an arm attached at the roll axis,
a yaw drive mechanism comprising one of a pulley or gear attached to the other arm of the yaw bracket at the yaw axis to vary the azimuth of the pointing direction of the camera core, and
a yaw-drive servo motor mounted engaging the yaw drive mechanism;
whereby all three of said pitch, roll and yaw axes are orthogonal and intersecting at a common point.

2. The rotate-pan-tilt-zoom video camera according to claim 1, wherein said roll drive mechanism comprises a pulley and said roll-drive servo motor is engaged to said roll drive pulley by a belt.

3. The rotate-pan-tilt-zoom video camera according to claim 1, wherein said pitch/roll mechanism comprises a pulley and said pitch-drive servo motor is engaged to said pitch drive pulley by a belt.

4. The rotate-pan-tilt-zoom video camera according to claim 1, further comprising:
a wheeled base;
a cabinet mounted on said base;
a mast extending vertically from said base;
an articulating boom extending from a top of said mast; and
an adjustable-beam light source mounted distally on said boom;
whereby said remote portable videoimaging unit may be wheeled into a convenient location for illumination.

5. In a videoimaging system, a video camera comprising:
a housing;
a modular camera core inside said housing and comprising a CCD imager, a zoom lens assembly, a mounting having a frontside at which said lens assembly is exposed, an opposing backside, and plurality of broadsides, and at least one circuit board on said mounting for video signal processing and pan, tilt and zoom control;
a remotely-controlled rotate-pan-tilt mount inside said housing for three-axis rotation of said camera core about three mutually orthogonal axes including a vertical yaw axis, a horizontal roll axis, and a horizontal pitch axis, said rotate-pan-tilt mount further comprising a roll drive gear attached coaxially at the backside of the camera core, a roll-drive servo motor mounted stationery inside said housing for engaging the roll drive gear to vary angular orientation of the field of view of camera core around the roll axis, a pitch/roll bracket formed as a right-angle with one arm attached at the roll axis at the rear of the camera core and another arm angled around the broadside of the camera core, a pitch drive gear attached to the other arm of said pitch/roll bracket coaxial with the pitch axis, a pitch-drive servo motor mounted inside the housing and engaging the pitch drive gear to vary the altitude of the pointing direction of the camera core, a yaw bracket formed as a right-angle with one arm wrapped around a broadside of the camera core and attached at the roll axis, a yaw drive gear attached to the other arm of yaw bracket at the yaw axis, and a yaw-drive servo motor mounted inside the housing and engaging the yaw drive gear to vary the azimuth of the pointing direction of the camera core around the yaw axis, all three of said pitch, roll and yaw axes being orthogonal and intersecting at a common point,
whereby said videoimaging system may be controlled by a single operator for producing a live video feed.

6. A portable lighting unit according to claim 5, further comprising:
a wheeled base;
a cabinet mounted on said base;
a mast extending vertically from said base;
an articulating boom extending from a top of said mast; and
an adjustable-beam light source mounted distally on said boom;
whereby said remote portable videoimaging unit may be wheeled into a convenient location for illumination.
